(19) United States
(12) Patent Application Publication
(10) Pub. No.: US 2002/0023265 A1
(43) Pub. Date: Feb. 21, 2002

(54) Wireless controller with publicly-accessible communications link for controlling the content seen on large-screen systems

(76) Inventor: Darrell J. Metcalf, Fillmore, CA (US)

Correspondence Address: Darrell J. Metcalf, 905 N. Oak Avenue, Fillmore, CA, 93015, US

(21) Appl. No.: 09/925,093

(22) Filed: Aug. 7, 2001

Related U.S. Application Data
(60) Provisional application No. 60/223,700, filed on Aug. 8, 2000.

(51) Int. Cl. H04N 7/18

(52) U.S. Cl. 725/74; 725/81

(57) ABSTRACT

The present invention generally relates to a method and system for communicating signals between handheld wireless communications devices and large-screen projection systems, or large-screen display systems, or both, via one or more publicly-accessible communications link. The invention provides the means for such devices to serve as interactive controllers of screen-content which is projected, or otherwise displayed, on such screen systems. More specifically, the wireless devices are personal digital assistants (PDAs), cell phones and the like, each having finger or thumb-operated push-buttons, or rotatable dials, or touch-screen operations, or any combination thereof, from which control signals are initiated by a user and then communicated through one or more communications link such as: the international global network (Internet); or via wireless services provided by one or more telephony service providers; or via other radio wave transmission; or light wave transmission, such that the control signals cause desired interactive control of content on one or more of the screen-systems according to user input.

### CROSS-REFERENCE TO RELATED APPLICATION

This is a non-provisional application which relies on provisional application #60/223700 filed Aug. 8, 2000.

### FIELD OF THE INVENTION

The present invention generally relates to a method and system for communicating signals between handheld wireless communications devices and large-screen projection systems, or large-screen display systems, or both, via one or more publicly-accessible communications link. The invention provides the means for such devices to serve as interactive controllers of screen-content which is projected, or otherwise displayed, on such screen systems. More specifically, the wireless devices include personal digital assistants (PDAs), cell phones and the like, each having finger or thumb-operated push-buttons, or rotatable dials, or touch-screen operations, or any combination thereof, from which control signals are initiated by a user and then communicated through one or more communications link such as: the international global network (Internet); or via wireless services provided by one or more telephony service providers; or via other radio wave transmission; or light wave transmission, such that the control signals cause desired interactive control of content on one or more of the screen-systems according to user input.

### BACKGROUND OF THE INVENTION

In co-pending patents, the applicant of the present invention shows and describes various display systems, including immersive large-screen displays, that are suitable for the imaging of any one or more in a variety of projectable media content, or displayable media content, onto large-screens. In one of the co-pending patents, a cylindrical screen is shown which can be configurable into an oval shape, or circular shape, and is positionable in height relative to an audience such that a dual-perspective is offered, providing a circularity of action that can be seen on the screen. For example, when an audience views a dual-perspective screen from a vantage point outside of its outer perimeter while also viewing the screen from a vantage point below its lower perimeter, an oval car race can be seen in a contiguous and substantially circular action: a car appears on the leftmost side of the oval screen's outer perimeter and races to the rightmost side, after which, it appears on the inner perimeter of the screen and races from right to left (see illustrations for more details).

While such screens are ideal for portraying oval-track format races of various sporting events e.g. NASCAR Short-Track, horse races, Olympic ice skating, track & field, velodrome and the like, it is also possible to use such screens for oval-track video games and for people to interact with such games using handheld communications devices such as those proposed in the present invention.

For example, in the present invention, one or more intelligent controller(s) or microprocessor(s), control circuit(s) and software controlled by a telephony service provider, or other wireless communications network, are responsive to user-initiated control signal sent from wireless handheld devices such as cellular phones and PDAs. The wireless handheld devices have one or more user-input means to generate transmittable control signals including, but not limited to: a plurality of buttons, one or more rotatable dials, a microphone, or stylus-entry touch-sensitive screen. The control signals are assignable, or predetermined, such that when an intelligent controller receives one or more transmitted control signals, the signal(s) is interpreted to effect screen content, or the movement of one or more screen-element, or one or more video game sprites, in a predictable manner on a rectangular, or arced, or domed, or panoramic, screen. Thus, in the example of an oval car race on a panoramic screen, a user preferably first enters an access code to become a race participant: by pressing the proper sequence of buttons (e.g. alpha-numeric buttons) on the handheld device. Following the optional user-confirmation, the race can begin and user-input means, such as any of those previously described, can be used for controlling any one or more of a variety of race car characteristics, such as a car's: acceleration, steering, braking, gear shifting, and so on. Additionally, some control signals are sustainable, for example, the depression of a button can be sustained as desired (e.g. as a sustained tone), or a rotatable dial rotated to and held in a particular position, or a vocalized sound can be sustained, in each case, the acceleration, breaking, and steering of the race car as needed. Similarly, the buttons are assignable, or predetermined, according to the game played, for example, in the case of a game that simulates a battle, one or more user-input means can be used to control movement of an on-screen game character, or machine, or control weapons, or a character's weapons, and so on. Also, the user-input means can be employed for game selection, and the selection of game parameters can also be facilitated e.g. setting game-difficulty levels, game equipment options, and the like. The game choices and selections offer the types of utility, function and parameter settings of conventional video games that are viewed on a television screen. Such choices can be facilitated by real-time on-screen setup instructions such as those typically used to accept button-selection setup and choices, or can also be facilitated through a website having an user-interface (and software) that assists a user in configuring his or her button-choices and selections relative particular games.

Although, car-racing has been mentioned as a specific example of a type of game that can be controlled by the buttons of handheld devices having a suitable publicly-accessible communications link, it is also noted that any one or more in a variety of games are possible, and that numerous other, or new, games can be created to take advantage of the portability of such devices, and the public interactivity of one or more player/participants. Furthermore, it is also possible to have games that change or morph predictably according to pre-determined game thresholds, or that unexpectedly morph from one type of game to another. For example, a race may begin with NASCAR-type race cars and suddenly switch each racing machine into a RENO air-race airplane flying around an oval course in the same, or opposite, direction. The aircraft may then switch into horses, or horses with carriages or chariots, and then to any in a variety of boats or ships, and so on. The system can also accommodate player interactivity by participants at different locations, such that a user at one location causes on-screen events to occur at one or more other location. The buttons of the wireless handheld devices are not limited to the control of games or game elements, the handheld devices can also be used to cause the switching of screen imagery including: cuts, dissolves, fades and the like (from one image, or composite of images, to another).

The system comprises commercially-available equipment for establishing a publicly-accessible communications link between one or more handheld devices and a wireless communications network, or telephony service provider. The system includes the type of wireless communications equipment commonly employed to establish a communications link with handheld devices of a type that are used in public places. Control signals initiated from a wireless device are directed by suitable signal control means to one or more intelligent controllers such as the combination of at least one microprocessor and software and/or firmware that are collectively responsive to the control signals. The microprocessor is powered by a suitable power supply, and in at least one embodiment of the system, includes software or firmware routines to create, maintain, amend and query, a storable database of assignable button choices and button parameters. In one embodiment the database is also accessible from one or more websites via the international global network (Internet).

### PRIOR ART

Investigation of patent documents has not yielded any prior art that seeks or accomplishes the benefits and advantages of the present invention via a publicly-accessible communications link between one or more handheld devices and a wireless communications network—suitable for wireless communications with handheld devices of a type that are used in public places, and of a type that provides interactivity with one or more public large-screen projection or display systems.

### SUMMARY OF THE INVENTION

In accordance with the present invention, a public system for wirelessly controlling content seen on large-screen systems is disclosed. The system comprises at least one publicly-accessible large-screen display and display means for imaging screen-content onto the display. The display means can include any one or more in a variety of known type of imaging equipment including: one or more projectors and projection screens. The projection screens can be of type for receiving front or rear projections. Alternatively, the screens can be formed of, or braced by, or made self-supporting, comprising one or more materials having sufficient rigidity to be self-supporting and/or comprised of pixelated material or a matrix of pixel elements. The system also comprises at least one wireless handheld device having user-input means suitable for sending at least one type of control signal initiated by a user and for transmitting the control signal(s) as identifiable control events or control signals. Such input means can include any one or more in a variety of known type of inputs from a wireless phone and/or personal digital assistant (PDA) including: push-button input, rotatable dial input, voice input (including voice-recognition vocal events), touch-screen input, stylus input (whether tapped in a particular spot of a touch-screen, or representing one or more stylus paths). The wireless handheld devices are suitable for establishing a communications link with a publicly-accessible wireless communications network. The network can include any one or more in a variety of known networks including: the international global network (Internet); a wide area network (‘WAN’); a local area network (‘LAN’); or, a telephony service provider such as Pacific Bell (in southern California), Cellular One (cell phone service provider), or Verizon Inc., Verizon Wireless, AT&T, and the like. The wireless communications network provides a communications link with one or more electrically powered intelligent controller such as a microcontroller and control-circuit. The intelligent controller includes any one or more in a variety of known hardware, software and circuitry suitable for receiving and interpreting control signals of a type transmittable from one or more wireless handheld devices—and for controlling screen-content on one or more large-screen display in response to such user-input from the wireless device(s). The wireless communications network also provides control signal reception means such as any in a variety of known hardware, software and circuitry suitable for receiving control signals initiated by a wireless phone and/or personal digital assistant (PDA) and for routing such signals to one or more intelligent controller(s). The system also provides interactive control and optionally, parameter configuring of one or more video-game system and/or one or more video system, wherein at least one non-volatile memory is used for storing and retrieving parameters. The system also optionally provides storable and retrievable database records such game-in-progress status, game scores and so forth. The video-game system(s) and the video system(s) provide video signal output of controllable screen-content such that the screen-content, or screen-elements thereof, can be controlled, or switched, or modulated, by a wireless device used by one or more user, including one or more user at different locations when more than one large-screen display is employed at different locations.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a block diagram illustrating components employed in the system for wirelessly controlling content seen on large-screen systems including means for receiving control signals from wireless handheld devices and means for interpreting those signals to determine controllable screen-content.

FIG. 2 is partial three-dimensional view of a large-audience venue such as an arena, having a cylindrically configured screen suspended thereabove such that a multiplicity of vantage points providing a dual-perspective of an interior perimeter and exterior perimeter of the screen are offered and a circularity of action on the screen can be seen from those vantage points. Wireless handheld devices are depicted in communication with a wireless communications network to effect controllable screen-content (using wireless communications network components shown in FIG. 1).

### DESCRIPTION OF THE PREFERRED EMBODIMENT

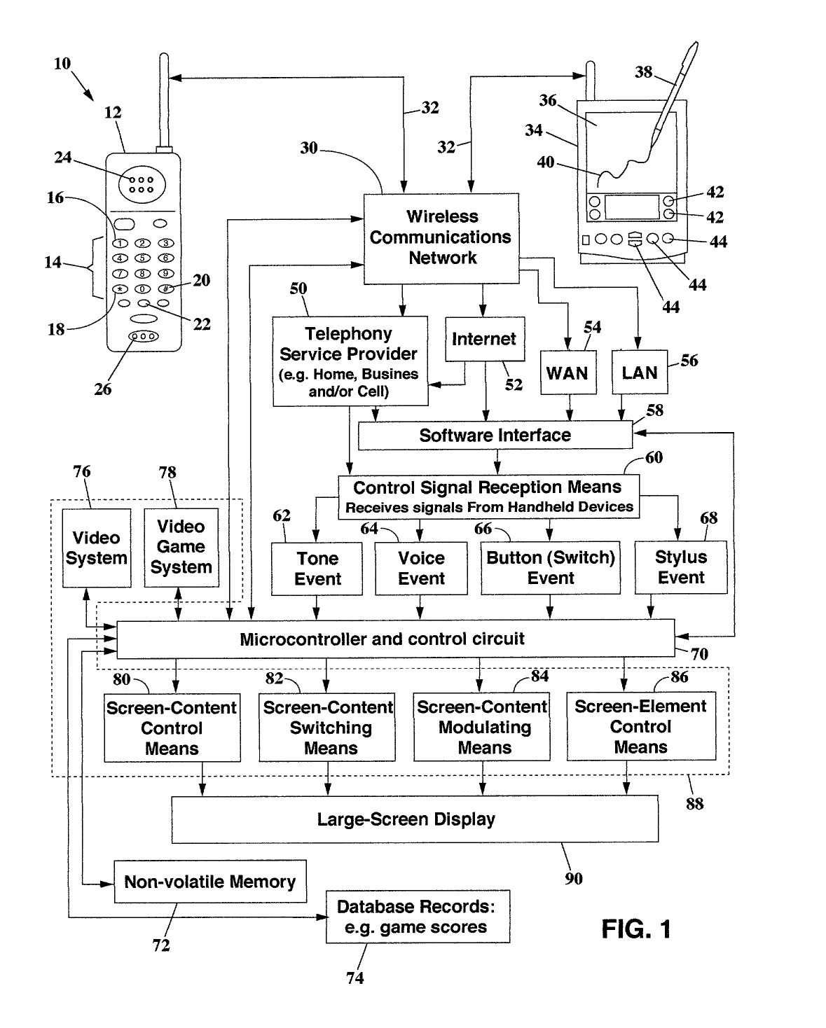

With reference to FIG. 1, the principal components used to implement the present invention are seen in wireless controller system 10 which includes wireless handheld devices such as wireless telephone 12 and wireless personal digital assistant ‘PDA’ 34 each shown having a wireless communications link 32 with at least one publicly-accessible wireless communications network 30 such as a telephony service provider 50, Internet 52, WAN 54, LAN 56, or combinations thereof. The network 30 provides a communication link between telephone(s) 12, or PDAs 34, and one or more control signal reception means 60 which receives control signals from such portable or handheld devices. The control signals received by reception means 60 can include any one or more of the following event types: tone event(s) 62, voice event(s) 64, rotatable dial or button (switch) event(s) 66, or stylus event(s) 68, and the like.

For example, when a user presses a button on dialpad 14 of wireless telephone 12 such as: ‘star’ button 18, or pound button 20, or an auxiliary button 22, or an alpha-numeric button 16, or when a PDA push-button 44 is pressed or dial is rotated, a tone event 62, or button (switch) event 66, is received by reception means 60 and routed as a discreet signal to at least one electrically-powered intelligent controller such as microcontroller and control circuit 70. In another embodiment of the invention, reception means 60 is interactive with voice-recognition software (not shown in FIG.1) such as a type that is commercially available to individuals or businesses for deciphering and implementing a plurality of voice commands. In such a case, reception means 60 receives voice commands sent through a microphone 26 of telephone 12. It deciphers them and sends each command as a discreet voice event 64 to microcontroller and control circuit 70.

Another embodiment of the invention provides for the reception of PDA touch-screen events such as the pressing of a touch-screen button 42, or reception of another type of stylus event 68. For example, the result of the handwriting recognition of a PDA stylus 38 can be transmitted to network 30 as alpha-numeric characters (e.g. ASCII keys) in which case, each character is routable to reception means 60 and sent to microcontroller and control circuit 70 as a discreet stylus event 68. Other stylus events are also similarly transmittable, for example stylus path 40 information—which is defined by the vertical location and horizontal location of the stylus contact point on a PDA's touch-screen (and a contiguous movement from those points to other of such points)—can be transmitted to network 30 and routed through reception means 60 as stylus event 68 which in turn is sent to microcontroller and control circuit 70 as stylus path information.

Any one or more handheld device transmittable event, such as event(s) 62, 64, 66, and 68 are then employable to effect controllable screen-content 88. For example, microcontroller and control circuit 70 has interactive communications with at least one video system 76, or at least one video game system 78, or combinations thereof. In each case, user-input received from a wireless handheld device is used to control screen content via: screen-content control means 80; or screen-content-switching means 82, or screen-content modulating means 84; or screen-element control means 86; or, any combinations thereof. Means 80, 82, 84, and 86 are controlled by microcontroller and control circuit 70 according to user input/events and are comprised of any one or more in a variety of commercially available (or otherwise known) equipment suitable for controlling, switching, or modulating screen-content, or for controlling screen-elements, whether the source of the controllable screen-content 88 is provided by one or more video system, or by one or more video-game system. Thus, wireless handheld devices, of the system, provide a versatile controller means to effect the screen-content of one or more large-screen-display at one or more publicly-accessible venue.

With the employment of one or more video system 76 of wireless controller system 10, the physical push-buttons on telephone(s) 12, or on PDA(s) 34, or the graphically depicted buttons on a PDA's touch-screen, can be pre-assigned, or alternatively, programmed by the user, to effect any one or more in a variety of image controlling, switching, or modulating functions. For example, one or more push-button event, touch-screen event, stylus event, or voice event, can move an image, change an image, switch or modulate an image (e.g. cuts, fades, wipes, pans, dissolves, or other common video transitions or functions such as those effecting color ranges, color saturation, image sharpness, brightness, contrast, and so forth). For example, voice events can be used to switch video stills, or video action shots, such that the video system is responsive to recognizable voice commands and plays back imagery from a non-linear video storage according to video-image file category (such as a categorized video footage database record 74). Thus, a user speaking into the microphone of his or her wireless device can say a series of recognizable words such as: “waterfall”, “ocean”, “coral reef”, “mountains”, “sunset”, “skyline”, “constellations”, “New York city” and have video formatted imagery exhibited by such verbal definitions on one or more large-screen display at one or more locations.

Similarly, with the employment of one or more video-game system 78 of wireless controller system 10, the physical push-buttons on telephone(s) 12, or on PDA(s) 34, or the graphically depicted buttons on a PDA's touch-screen, can be pre-assigned, or alternatively, programmed by the user, to effect any one or more in a variety of image controlling, switching, or modulating functions. For example, one or more push-button event, dial event, touch-screen event, stylus event, or voice event, can move an image, change an image, switch or modulate an image (e.g. cuts, fades, wipes, pans, dissolves, or other common video transitions or functions such as those effecting color ranges, color saturation, image sharpness, brightness, contrast, and so forth). Alternatively, one or more of input events can similarly effect screen-elements of the currently-played video-game. Thus, it is possible to have screen-elements that are moved by tone events, voice events, button or dial (switch) events, and stylus events (or by any combinations thereof). For example, certain push-buttons can cause a car in a car-race video game to accelerate, or decelerate, or turn left, or turn right, change gears and so forth. Alternatively, the video-game system can be responsive to recognizable voice commands and change, switch move screen-elements according to recognizable voice commands such as “go”, “stop”, “slower”, “faster”, “right”, “left”, “up”, “down”, “jump”, “duck”, “dive”, “climb”, “fire”, “shoot”, “lookout!”and so forth.

Active user-input events are stored as pre-determined parameters, or alternatively as programmable parameters, in one or more non-volatile memory 72 of system 10. For example, when an auto race is exhibited on a large-screen display certain buttons on the PDA, or on dialpad 14 can be pre-assigned

Alternatively, the system optionally provides a software interface 58 that is responsive to user-input from a wireless device to facilitate on-screen selection of pre-determined, or programmable, parameters that effect screen-content of the video system(s) or video-game system(s). In one embodiment of the invention, the software interface is shown on an Internet website having text and/or graphic depictions of the (pre-assigned, or programmable) parameters. Computers, or PDAs, having website browsing means can access such a website for instructions and/or other interactive setup need(s). When parameters are programmable, the website interface offers means for browsing and selecting the parameters on-screen and for storing those parameters as needed according to the type of wireless device that will used. In another embodiment of the invention, video system parameters, and/or video-game parameters, are exhibited on one or more large-screen display 90 and the user can simply familiarize himself with needed information, and optionally scroll through the information by pressing one or more wireless device button (or by some other wireless device event among those previously described). For example, display 90 can show an access code on-screen, e.g. a telephone number, that users among a multiplicity of people must enter (dial) in order to qualify as an interactive participant with the video system(s) and/or video-game system(s). The system optionally provides a type of ‘Caller I.D.’ functionality such that users can be identified by name on-screen by the system's analysis of identification phone numbers, or other identifiable codes, which are associated with the connected qualified wireless devices.777

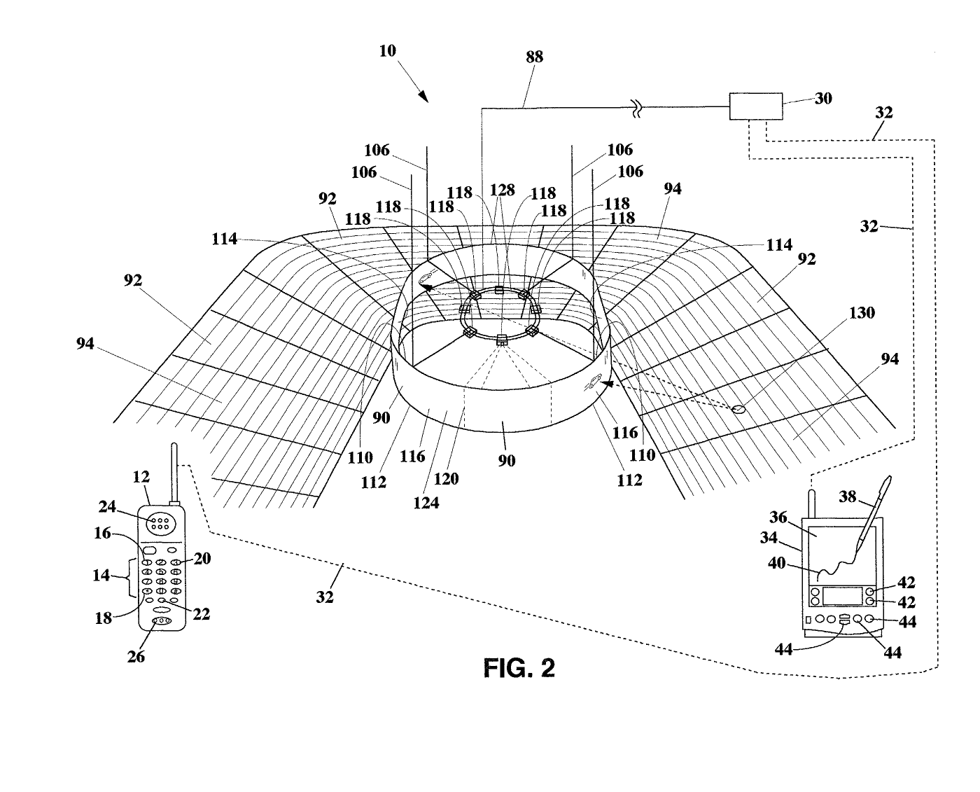

In FIG. 2, a large-screen display 90 is depicted having a cylindrical shape and is positionable by a plurality of screen support 106 above an arena venue 92 that has inward-facing seats 94 from which a multiplicity of dual-perspective vantage point 130 is offered. Display 90 is shown having an screen upper-perimeter 110, a screen lower-perimeter 112, a screen inner-perimeter 114, a screen outer-perimeter 116, such that a circularity of action is seen from each dual-perspective vantage point. For example, a car race seen from vantage point 130 would show a care racing from the leftmost side of a screen outer-perimeter 116 to a rightmost side thereof and then appear to be racing from right to left on a screen inner-perimeter 114 (as seen from under screen lower-perimeter 112). Such contiguous panoramic depictions can be exhibited on display 90 as a combination of projected screen segments 120 (shown in dashed lines) projected from an array of projectors 118 wherein such components comprise a display means 128. It is noted in a co-pending patent by the applicant of the present invention that although the screen inner-perimeter 114 is seen from beneath a lower-perimeter 112 of the display 90, the display means could instead be positioned by screen supports 106 to a height where screen lower-perimeter 112 is adjacent to, or near to, the floor at the center of the arena and much of the screen inner-perimeter 114 would be seen from dual-perspective vantage points that peer over screen upper-perimeter 110. Although display 90 is shown as a cylindrical and panoramic screen, it is noted that the large-screen displays of the present invention are not limited to such configurations. For example, large rectangular screens, can be used instead, such as the type used in large-screen theatres, or for IMAX® productions. In other words, screens employed by the system are not limited to shape, material or type. And user-input/event interactivity is also not limited to the shape, material or type of screen used.

In operation, regardless of the screen shape, material or type used, it can be seen that one or more buttons, or one or more events, received from wireless handheld devices by the system, can be interpreted to serve as control signals effecting the screen-content on one or more large-screen display located at one or more locations. As mentioned above, such events include voice commands in addition to tone or button events. Such that voice commands such as “left”, “right”, “up”, “down”, “faster”, “slower” and so forth can be used to direct the movement of a player's car in the case of an auto race (and other game elements in other games). User-input also include various stylus events, including the means to translate stylus paths drawn on a PDA touch-screen into directions to move a player's car in the case of an auto race (and other game elements in other games). When the stylus point goes up on a touch-screen the game element can also go up. When the stylus goes to the right the element e.g. a race-car can go faster, when the stylus goes left on the touch-screen the car can slow down, and so on. The stylus events can also be translated as alpha-numeric events for games or quizzes requiring text and/or number entries, or for playing games on-screen that require any in a variety of user-inputted indicia e.g. an “X” or “O” in a tic-tac-toe game, or for drawing a certain type of image on-screen, and so forth.

The user establishes a connection with one or more wireless communications network 30 via a wireless communications link 32 to initiate interactive participation at one venue and can have versatile video-game (or video system) wireless controller interactivity with one or more screen at the same venue, while optionally interactively playing the same video-game with an opponent—on a screen suitable for the displaying the game—located at another venue. Similarly, users at one or more venues can use transmittable events from their respective wireless handheld devices to control, switch or modulate controllable screen-content 88 that is derived from one or more video systems. Game scores, or the status of games that are paused for subsequent play, can be stored and retrieved from one or more database records 74.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by the disclosure of the specification and by reference to the claims that follow. Following:

1. Public system for wirelessly controlling content seen on large-screen systems comprising:
a.) at least one publicly-accessible large-screen display and display means for imaging screen-content onto said large-screen display;
b.) at least one wireless handheld device having user-input means for transmitting at least one type of control signal from said device;
c.) said wireless handheld device(s) suitable for establishing a communications link with a publicly-accessible wireless communications network;
d.) said wireless communications network having at least one electrically powered microcontroller, at least one control-circuit, and software for receiving and interpreting said control signals, and for controlling screen-content of at least one video system, on said large-screen display, according to said user-input; and
e.) said wireless communications network having control signal reception means suitable for receiving said control signals and for routing same to said microcontroller(s).

2. The large-screen display of claim 1 comprising at least one projection screen and at least one projector to project user-input controlled video signal.

3. The projection screen(s) of claim 2 comprising a screen material suitable for rear-projection.

4. The large-screen display of claim 1 comprising a screen composed of a multiplicity of pixel elements.

5. The wireless handheld device(s) of claim 1 consisting of a wireless telephone having user-input means suitable for taking at least one type of control input from a user and transmitting same as identifiable control signals.

6. The wireless telephone and identifiable control signals of claim 5 wherein said user-input means is provided by at least one of said telephone's push-buttons and said identifiable control signals are provided by a transmittable signal generated during the depression of any of said push-button(s).

7. The wireless telephone and identifiable control signals of claim 5 wherein said user-input means is provided through said telephone's mouthpiece and said identifiable control signals consist of at least one vocalized sound, wherein;
at least one microcontroller of the system provides voice recognition software routines suitable for interpreting said vocalized sound(s) and
for outputting screen-content control signals in response to said control signals.

8. The wireless handheld device(s) of claim 1 consisting of a wireless Personal Digital Assistant (‘PDA’) having user-input means suitable for taking at least one type of control input from a user and transmitting same as identifiable control signals.

9. The wireless PDA and identifiable control signals of claim 8 wherein said user-input means is provided by at least one of said PDA's push-buttons and said identifiable control signals are generated during the depression of any of said push-button(s).

10. The wireless PDA and identifiable control signals of claim 9 wherein said user-input means is provided by at least one touch-screen event of said PDA and said identifiable control signals are generated in response to any of said touch-screen event(s).

11. The identifiable control signals of claim 10 wherein said touch-screen events of said PDA are provided by handwriting recognition of a PDA stylus when writing on said touch-screen and said control signals are comprised of characters interpreted by the PDA handwriting recognition software.

12. The identifiable control signals of claim 10 wherein said touch-screen events of said PDA are provided by the tap of a PDA stylus at a particular location on said touch-screen.

13. The identifiable control signals of claim 10 wherein said touch-screen events of said PDA are provided by movement of a PDA stylus on said touch-screen.

14. The wireless handheld device(s) of claim 1 consisting in the combination of a wireless phone and a wireless Personal Digital Assistant.

15. The communications link and publicly-accessible wireless communications network of claim 1 consisting of a connection with at least one telephony service provider.

16. The communications link and publicly-accessible wireless communications network of claim 1 consisting of at least one connection with the international global network, commonly referred to as the ‘Internet’.

17. The communications link and publicly-accessible wireless communications network of claim 1 consisting of a connection with at least one wide area network, commonly referred to asa ‘WAN’.

18. The communications link and publicly-accessible wireless communications network of claim 1 consisting of a connection with at least one local area network, commonly referred to as a ‘LAN’.

19. The microcontroller and control circuit of claim 1 further comprising an interactive communications link with at least one video-game system, said video-game system(s) comprising:
a.) at least one interactive software game;
b.) input circuitry for receiving input-controller information from said control signal(s) in order to control game parameters
c.) video-output circuitry for outputting video-game screen-content to said large-screen display
d.) video-output circuitry for controlling video-game screen-content on said large-screen display according to user-input.

20. The microcontroller and control circuit of claim 1 further comprising a communications link with at least one video system, said video system(s) comprising:
a.) video hardware and software, and input circuitry for receiving and interpreting input-controller information from said control signal(s) in order to control video parameters
b.) video-output circuitry for outputting video screen-content to said large-screen display
c.) video-output circuitry for controlling video screen-content on said large-screen display in response to user-input.

21. The video hardware and software of claim 20 further comprising means for controlling screen-content on said large-screen display.

22. The video hardware and software of claim 20 further comprising means for switching screen-content on said large-screen display.

23. The video hardware and software of claim 20 further comprising means for modulating screen-content on said large-screen display.

24. The video hardware and software of claim 20 further comprising means for controlling screen-elements on said large-screen display.

25. The system of claim 1 further comprising a communications link between said microcontroller(s) and at least one non-volatile memory to store user-input programmable parameters and to retrieve same therefrom as needed.

26. The system of claim 1 further comprising a communications link between said microcontroller(s) and at least one non-volatile memory to retrieve pre-assigned parameters therefrom as needed.

27. The system of claim 1 further comprising a communications link between said microcontroller(s) and at least one updateable database record to store game-related information and to retrieve same therefrom as needed.

28. The system of claim 1 further comprising at least one software routine that provides access to the system upon receipt of at least one acceptable access-code sent from a wireless handheld device.

29. The access-code(s) of claim 28 consisting of at least one telephone number.

30. The video system(s) of claim 1 further comprising a software interface responsive to user-input from a wireless device to facilitate on-screen selection of pre-determined parameters that will effect screen-content of said video system(s).

31. The video system(s) of claim 1 further comprising a software interface responsive to user-input from a wireless device to facilitate on-screen selection of programmable parameters that will effect screen-content of said video system(s).

32. said wireless communications network(s) of claim 1 further comprising caller-identification means for automatically identifying a caller who has established a communications link with said network(s).

33. Public system for controlling content seen on large-screen systems comprising:
a.) at least one publicly-accessible large-screen display and display means for imaging screen-content onto said large-screen display;
b.) at least one wireless phone having user-input means suitable for taking at least one type of control input from a user and transmitting same as identifiable control signals;
c.) said wireless phone suitable for establishing a communications link with a publicly-accessible wireless communications network;
d.) said wireless communications network having at least one electrically powered microcontroller and control-circuit for receiving and interpreting said control signals, and for controlling screen-content derived from at least one video system, on said large-screen display in response to said user-input; and
e.) said wireless communications network having control signal reception means suitable for receiving said control signals and for routing same to said microcontroller(s).

34. Public system for controlling content seen on large-screen systems comprising:
a.) at least one publicly-accessible large-screen display and display means for imaging screen-content onto said large-screen display;
b.) at least one wireless Personal Digital Assistant (PDA) having user-input means suitable for taking at least one type of control input from a user and transmitting same as identifiable control signals;
c.) said wireless Personal Digital Assistant suitable for establishing a communications link with a publicly-accessible wireless communications network;
d.) said wireless communications network having at least one electrically powered microcontroller and control-circuit for receiving and interpreting said control signals, and for controlling screen-content derived from at least one video system, on said large-screen display in response to said user-input; and
e.) said wireless communications network having control signal reception means suitable for receiving said control signals and for routing same to said microcontroller(s).
